(19) United States
(12) Patent Application Publication
(10) Pub. No.: US 2019/0281275 A1
(43) Pub. Date: Sep. 12, 2019

(54) FORMING A STEREOSCOPIC PAIR OF IMAGES USING A SINGLE CAMERA

(71) Applicant: Toyota Research Institute, Inc., Los Altos, CA (US)

(72) Inventors: Nikolaos Michalakis, Saratoga, CA (US); Julian M. Mason, Redwood City, CA (US)

(21) Appl. No.: 15/916,673

(22) Filed: Mar. 9, 2018

(51) Int. Cl. H04N 13/204; H04N 13/106; G02B 27/22

(52) U.S. Cl. CPC H04N 13/204; G02B 27/22; H04N 13/106

(57) ABSTRACT

Systems and methods for forming a stereoscopic pair of images are described. A camera is operatively connected to a rotating member that rotates about an axis of rotation. The camera captures a first image representing a portion of an environment. As the camera rotates with the rotating member, the camera captures a second image that represents substantially the same portion of the environment with a perspective offset from the first image. The first and/or second images are rectified such that, following rectification, the first and second images are aligned and thereby form a stereoscopic pair of images.

### TECHNICAL FIELD

The subject matter described herein relates generally to imaging and, more specifically, to forming a stereoscopic pair of images.

### BACKGROUND

Stereo imaging is a relatively recent development. Two images are captured by two cameras spaced apart from one another and having the same perspective. These images can be processed to determine a distance between the cameras and a feature located within the field of view of the cameras. However, providing two cameras can be expensive to implement. Further, these two cameras must be properly aligned. If the two cameras are not properly aligned, additional image processing is required. Otherwise, the calculation of the distance between the cameras and the feature may not be accurate.

### SUMMARY

The present disclosure describes forming a stereoscopic pair of images using one camera. As such, the disclosed systems and methods are relatively inexpensive to implement. The camera rotates about an axis of rotation and captures at least two images, which are rectified to form an aligned stereoscopic pair of images. As a result, implementing the disclosed systems and methods reduces the risk of inaccurate processing and calculation due to misalignment.

In one example, a system for forming a stereoscopic pair of images is described. The system can include a rotating member having an outwardly facing surface. The rotating member can rotate about an axis of rotation extending through the outwardly facing surface. The system can include a camera operatively connected to the outwardly facing surface of the rotating member between the axis of rotation and a perimeter of the rotating member. The camera can have a field of view extending outwardly from the outwardly facing surface of the rotating member. The camera can rotate with the rotating member about the axis of rotation. The system can include a processor operatively connected to the camera. The system can include memory operatively connected to the processor. The memory can store instructions that, when executed by the processor, cause the processor to capture a first image representing a portion of an environment with the camera. The memory can also store instructions to capture a second image as the camera continues to rotate about the axis of rotation with the rotating member. The second image can represent substantially the same portion of the environment as the first image. The second image can have a perspective offset from the first image. The memory can also store instructions to rectify the second image such that the first image and the rectified second image are aligned, wherein the first image and the rectified second image form a stereoscopic pair of images.

In another example, a method of forming a stereoscopic pair of images is described. The method can include capturing a first image representing a portion of an environment with a camera having a field of view extending in a direction, the camera mounted to a rotating member having an axis of rotation extending in the direction of the field of view of the camera, the camera rotating with the rotating member. The method can include, as the camera rotates about the axis of rotation with the rotating member, capturing a second image, the second image representing substantially the same portion of the environment as the first image, the second image having a perspective offset from the first image. The method can include rectifying the second image such that the first image and the rectified second image are aligned, wherein the first image and the rectified second image form a stereoscopic pair of images.

In another example, a method of forming a stereoscopic pair of images is described. The method can include capturing a first image representing a portion of an environment with a camera having a field of view extending in a direction, the camera mounted to a rotating member having an axis of rotation extending in the direction of the field of view of the camera, the camera rotating with the rotating member. The method can include, as the camera rotates about the axis of rotation with the rotating member, capturing a second image, the second image representing substantially the same portion of the environment as the first image, the second image having a perspective offset from the first image. The method can include rectifying the first image such that the rectified first image and the second image are aligned, wherein the rectified first image and the second image form a stereoscopic pair of images.

### BRIEF DESCRIPTION OF THE DRAWINGS

FIGS. 1A-1B show a view of a rotating camera arrangement for capturing images usable to form a stereoscopic pair of images.

FIGS. 2A-2B show another view of the rotating camera arrangement of FIGS. 1A and 1B.

FIG. 3 is an example of two images captured using the camera arrangement of FIGS. 1A and 1B.

FIG. 4 is another example of two images captured using the camera arrangement of FIGS. 1A and 1B.

FIG. 5 is an example of rectified images corresponding to the example images of FIG. 3 and FIG. 4.

FIG. 6 a flowchart depicting an example method of forming a stereoscopic pair of images.

### DETAILED DESCRIPTION

Systems and methods for forming a stereoscopic pair of images are described. A camera is operatively connected to a rotating member that rotates about an axis of rotation. The camera captures a first image representing a portion of an environment. As the camera rotates with the rotating member, the camera captures a second image that represents substantially the same portion of the environment with a perspective offset from the first image. The first and/or second images are rectified such that, following rectification, the first and second images are aligned and thereby form a stereoscopic pair of images.

The arrangements disclosed herein can reduce hardware costs in many computer systems. The arrangements disclosed herein can simplify the formation of stereoscopic images. The arrangements disclosed herein can lessen accuracy requirements in mounting of multiple cameras for forming stereoscopic images. Many additional benefits of the disclosed arrangements will become apparent upon further discussion below.

The arrangements disclosed herein can be used in many robotic and/or vehicular applications where an accurate distance is needed or desirable. For instance, the described arrangements can be used in advanced control systems for controlling actuators. As one example, the described arrangements can be implemented on a vehicle and used for detecting a distance to an object in an environment. The vehicle can then determine travel path based, at least, on the distance to the object. The vehicle can then control one or more vehicle actuators to implement the determined travel path. As another example, the described arrangements can be implemented on a robot, and can be used for detecting a distance to an object in the environment. The robot can then determine one or more maneuvers based on the object. The maneuvers can include, for instance, handling the object, avoiding the object, etc. The robot can then control one or more robotic actuators to implement the determined maneuvers.

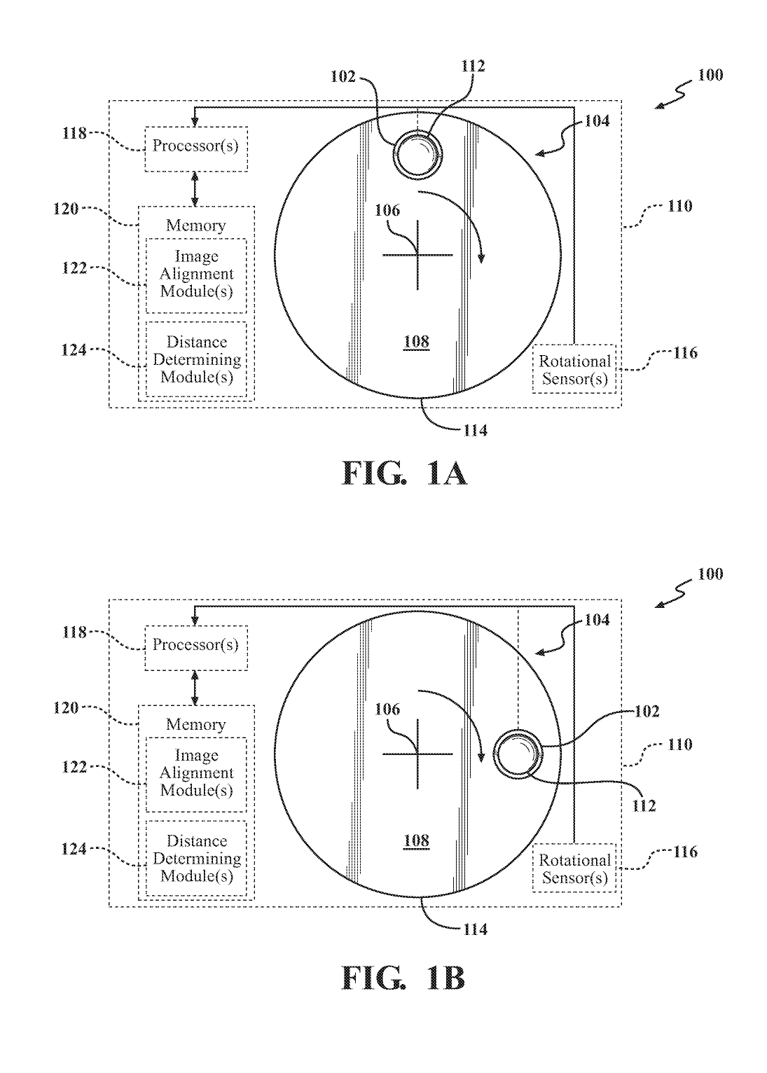

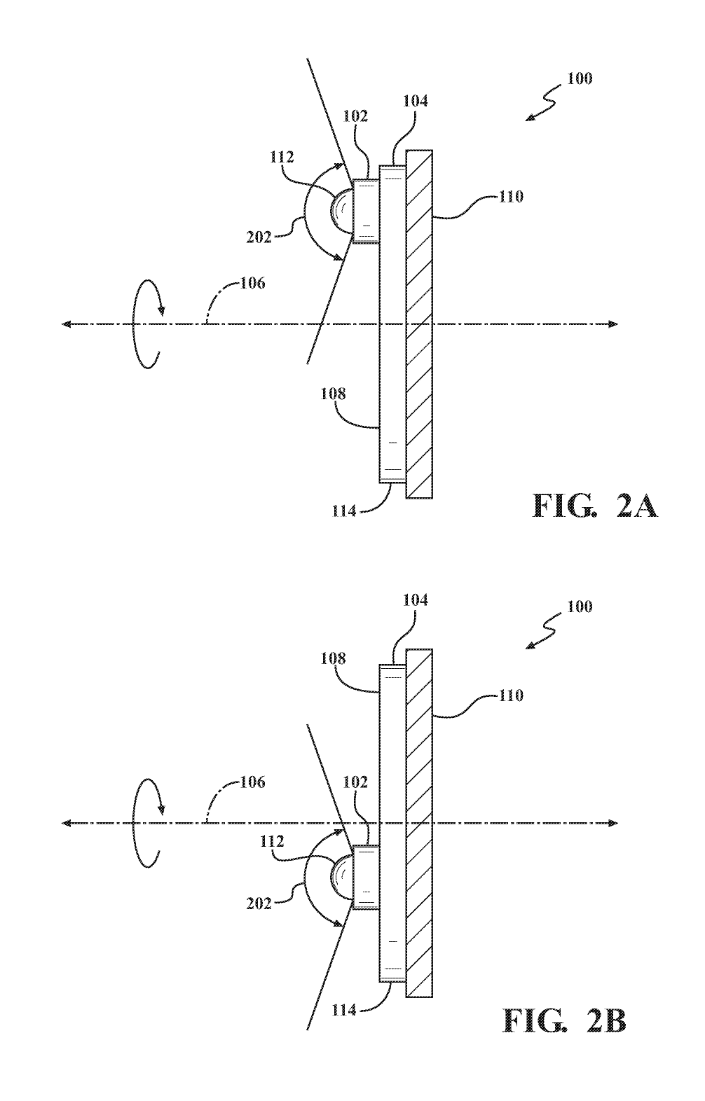

Referring to FIG. 1A and FIG. 1B, a camera arrangement 100 is shown. The camera arrangement 100 includes a camera 102 and a rotating member 104. The rotating member 104 can rotate about an axis of rotation 106. As shown, the axis of rotation 106 can be located within the rotating member 104. Specifically, the axis of rotation 106 can extend through an outwardly facing surface 108 of the rotating member 104. In some examples, the axis of rotation 106 can be perpendicular to the outwardly facing surface 108 of the rotating member 104 (such as in the examples shown in FIG. 2A and FIG. 2B).

In some instances, the rotating member 104 may be an object, component, or device that was previously designed to rotate. For instance, the rotating member 104 may be a wheel of a vehicle or a robot (not shown). In this regard, the arrangements described herein may use existing vehicle or robotic components to implement the disclosed systems/methods. In other instances, the rotating member 104 may be an object, component, or device that is specifically designed to rotate to implement the present disclosure. For instance, the rotating member 104 may be a plate connected to a motor (not shown). The rotating member 104 may be implemented on a vehicle, in robotics, etc. In this regard, the arrangements described herein may use new hardware for implementing the disclosed systems/methods.

The rotating member 104 can be fixedly attached to a body 110. As such, at least the outwardly facing surface 108 of the rotating member 104 can rotate with respect to the body 110. The body 110 can be a vehicle (or a portion thereof), a robot, etc. In some instances, the rotating member 104 can include a rotating portion and a fixed portion. The fixed portion can be directly coupled to the body 110. The rotating portion can be located between the outwardly facing surface 108 and the fixed portion.

The camera 102 can include a lens 112 and an image capture element (not shown). The image capture element can be any suitable type of image capturing device or system, including, for example, an area array sensor, a Charge Coupled Device (CCD) sensor, a Complementary Metal Oxide Semiconductor (CMOS) sensor, or a linear array sensor, just to name a few possibilities. The image capture element may capture images in any suitable wavelength on the electromagnetic spectrum. The image capture element may capture color images and/or grayscale images. One or more of the cameras can be configured with zoom in and/or zoom out capabilities.

The camera 102 can be operatively connected to the outwardly facing surface 108 of the rotating member 104. The term “operatively connected,” as used throughout this description, can include direct or indirect connections, including connections without direct physical contact. Accordingly, the camera 102 can be directly or indirectly connected to the outwardly facing surface 108 of the rotating member 104. As shown, the camera 102 is operatively connected to the outwardly facing surface 108 between the axis of rotation 106 and a perimeter 114 of the rotating member 104. It should be noted that, while the rotating member 104 is shown as having a circular shape, the rotating member 104 can have any shape, so long as the rotating member 104 can rotate about the axis of rotation 106.

Referring now to FIG. 1A-FIG. 2B, the camera 102 can be operatively connected to the rotating member 104 such that the lens 112 of the camera 102 extends outwardly from the outwardly facing surface 108. In this regard, the camera 102 can have a field of view 202 extending radially from the outwardly facing surface 108. “Field of view,” as used herein, is defined as a portion of the environment within which the camera can detect electromagnetic waves via the lens and image capture element (e.g., a portion of the environment observable by the camera). As shown in the progression between FIG. 2A and FIG. 2B, as the camera 102 rotates with the rotating member 104, the field of view 202 remains substantially the same in that much of the same portion of the environment is observable by the camera 102 as the camera 102 rotates with the rotating member 104 about the axis of rotation 106. While the field of view 202 remains substantially the same, the perspective changes as the camera 102 rotates. “Perspective,” as used herein, is defined as a point of view of the camera with respect to the environment. As the camera 102 rotates with the rotating member 104, the perspective changes since the position (and thus the point of view) changes. This can be best seen in the progression from FIG. 2A to FIG. 2B, where the perspective changes as the rotating member 104 rotates.

Referring back to FIG. 1A and FIG. 1B, the camera arrangement 100 can include one or more rotational sensors 116. The rotational sensor(s) 116 can be or include any devices, components, or group of devices and components capable of detecting a degree of rotation. The rotational sensor(s) 116 can be operatively connected to the rotating member 104. In one or more arrangements, the rotational sensor(s) 116 can be arranged to capture data corresponding to a degree of rotation for the rotating member 104. In some instances, the rotational sensor(s) 116 can generate an analog signal corresponding to a degree of rotation for the rotating member 104. For example, the rotational sensor(s) 116 can include a potentiometer arranged to change resistance according to the degree of rotation. The rotational sensor(s) 116 can then apply a voltage across the potentiometer and detect an analog signal corresponding to the resistance of the potentiometer. The analog signal can be communicated to an analog-to-digital (A/D) converter (not shown) that generates digital data corresponding to the degree of rotation. The digital data can coincide with the degree of rotation from 0° to 359°, for instance. While this example is provided, the rotational sensor(s) 116 can be other components and/or devices for generating an analog signal corresponding to the degree of rotation. Additionally, the rotational sensor(s) 116 can be configured to detect rotation beyond a single 360° rotation (e.g., 540°, 720°, etc., and intervals between and beyond). Furthermore, the rotational sensor(s) 116 can be digital rotational sensor(s) 116. In this example, the rotational sensor(s) 116 can directly generate digital data corresponding to the degree of rotation for the rotating member 104.

In one or more arrangements, the camera arrangement 100 can include one or more processors 118. The processor(s) 118 can include any component or group of components that are configured to execute, implement, and/or perform any of the processes or functions described herein or any form of instructions to carry out such processes or cause such processes to be performed. In one or more arrangements, the processor(s) 118 can be a main processor of the camera arrangement 100. Examples of suitable processors include microprocessors, microcontrollers, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 118 can include at least one hardware circuit (e.g., an integrated circuit) configured to carry out instructions contained in program code. In arrangements in which there are a plurality of processors, such processors can work independently from each other or one or more processors can work in combination with each other.

The camera arrangement 100 can include memory 120 for storing one or more types of data. The memory 120 store can include volatile and/or non-volatile memory. Examples of suitable memory 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 120 can be a component of the processor(s) 118, or the memory 120 can be operatively connected to the processor(s) 118 for use thereby. In some arrangements, the memory 120 can be located remotely from the camera arrangement 100 and accessible by the camera arrangement 100, such as via a communications device.

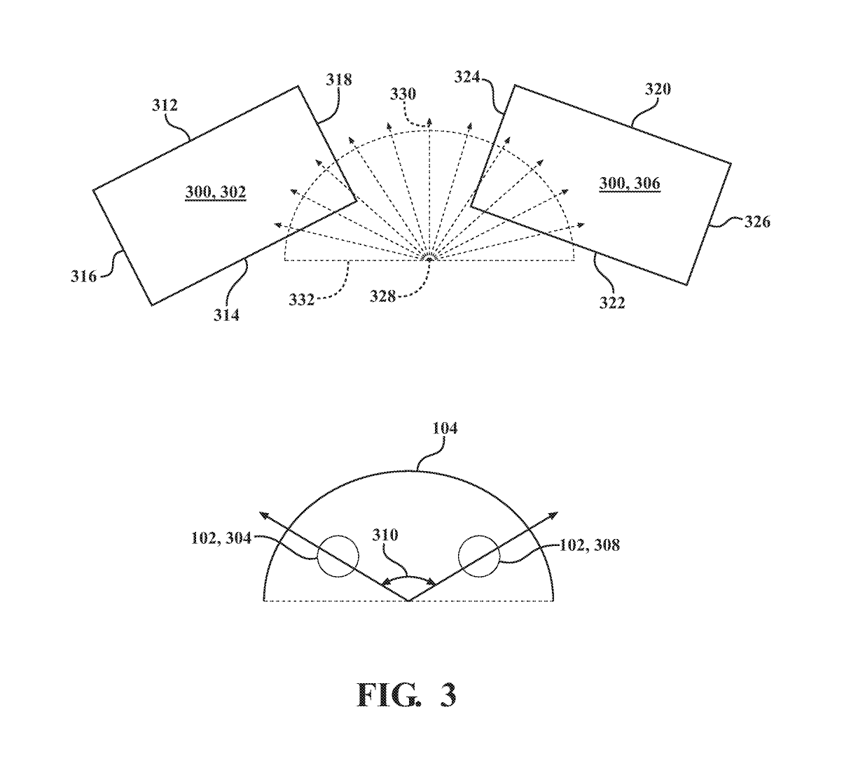

Referring briefly to FIG. 3, the camera 102 can be configured to capture images 300 as the camera 102 rotates with the rotating member 104. “Image,” as used herein, is defined as a digital representation of an environment as captured by a camera. The images 300 captured by the camera 102 correspond to the field of view 202 (of FIG. 2A-FIG. 2B) of the camera 102. Additionally, the images 300 share the perspective of the camera 102. Therefore, as the camera 102 rotates, the images 300 captured by the camera 102 change in perspective, yet have substantially the same field of view 202.

In some instances, the camera 102 can be programmed to capture the images 300. In other instances, the camera 102 can be controlled (e.g., by the processor(s) 118) to capture the images 300. The camera 102 can capture a first image 302 when the camera 102 is located at one position 304. As the camera 102 rotates, the camera 102 can then capture a second image 306 when the camera 102 is located at another position 308. The rotational sensor(s) 116 can detect a degree of rotation 310 of the rotating member 104 (and, correspondingly, the camera 102) between the camera 102 capturing images. Continuing the example, the rotational sensor(s) 116 can detect the degree of rotation 310 between the camera 102 capturing the first image 302 and the second image 306. In some instances, the degree of rotation is 180°. In other instances, the degree of rotation is different from 180° (such as the instances shown in FIG. 3).

Referring back to FIG. 1A and FIG. 1B, in one or more arrangements, the memory 120 can include various instructions stored thereon. For example, the memory 120 can store one or more modules. Modules can be or include computer-readable instructions that, when executed by the processor(s) 118, cause the processor(s) 118 to perform the various functions disclosed herein. While functions may be described herein for purposes of brevity, it is noted that the functions are performed by the processor(s) 118 using the instructions stored on or included in the various module(s) described herein. Some modules may be stored remotely and accessible by the processor(s) 118 using, for instance, various communication device(s) and protocols.

The memory 120 can store one or more image alignment modules 122. The image alignment module(s) 122 can include instructions that, when executed by the processor(s) 118, cause the processor(s) 118 to rectify one or more images 300 (of FIG. 3) captured by the camera 102. “Rectify,” as used herein, is defined as adjustment of one or more images to align one or more images with another image. Accordingly, the one or more images 300 can be rectified to align the one or more images 300 with another image. This rectification can simplify feature extraction and distance determination in analysis of a stereoscopic pair of images, as will be further discussed herein.

The image alignment module(s) 122 can include instructions to align the first image 302 and the second image 306. The image alignment module(s) 122 can include instructions to align the first image 302 and the second image 306 through one or more rotations and/or shifting of positions of the first image 302 and/or the second image 306.

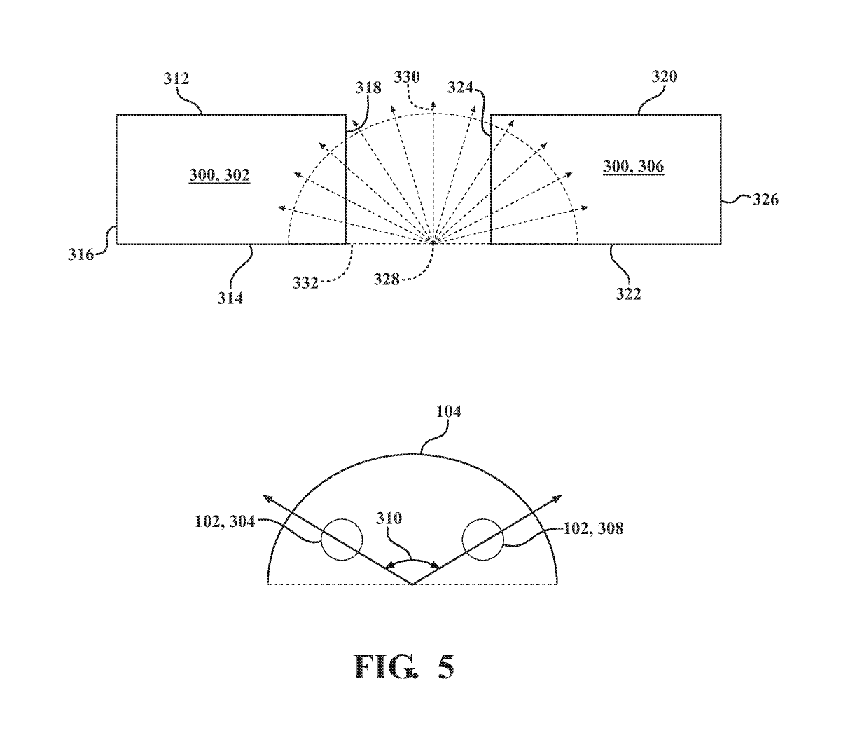

Referring now to FIG. 3-FIG. 5, the first image 302 can have a top 312, a bottom 314, a first side 316 and a second side 318. Similarly, the second image 306 can have a top 320, a bottom 322, a first side 324, and a second side 326. In one or more arrangements, one of the images 300 can be rectified with respect to another image 300. For instance, the image alignment module(s) 122 can include instructions to rectify the first image 302 with respect to the second image 306. In this example, the first image 302 can be adjusted such that the first side 316 and/or the second side 318 are parallel to any of the first side 324 and/or second side 326 of the second image 306. Additionally, the first image 302 can be adjusted such that the top 312 of the first image 302 is in line with the top 320 of the second image 306 (and/or the bottom 314 of the first image 302 is in line with the bottom 322 of the second image). Following rectification of the first image 302, the rectified first image 302 (as represented in in FIG. 5) is aligned with the second image 306. While this example, is provided, it should be understood that the image alignment module(s) 122 can include instructions to rectify the second image 306 with respect to the first image 302. Accordingly, the presented disclosure is not limited by which image of the first and second image 302, 306 is being rectified.

As another example, the image alignment module(s) 122 can include instructions to rectify two or more images 300 according to a coordinate system 328. For instance, the first image 302 can be adjusted according to a relationship of the first side 316 and/or the second side 318 with respect to a first axis (for example, axis 330). The adjustment of the first image 302 can include rotating the first image 302 such that the first side 316 and/or the second side 318 extend parallel to the first axis (for example, axis 330). Additionally, the first image 302 can be adjusted according to a relationship of the top 312 and/or the bottom 314 with respect to a second axis (for example, axis 332). The adjustment of the first image 302 can include rotating the first image 302 such that the top 312 is parallel to the second axis (for example, axis 332), and the bottom 314 is parallel and in-line with the second axis (for example, axis 332).

Similarly, the second image 306 can be adjusted according to a relationship of the first side 324 and/or the second side 326 with respect to the first axis (for example, axis 330). The adjustment of the second image 306 can include rotating the second image 306 such that the first side 324 and/or the second side 326 extend parallel to the first axis (for example, axis 330). Additionally, the second image 306 can be adjusted according to a relationship of the top 320 and/or the bottom 322 with respect to the second axis (for example, axis 332). The adjustment of the second image 306 can include rotating the second image 306 such that the top 320 is parallel to the second axis (for example, axis 330), and the bottom 322 is parallel and in-line with the second axis (for example, axis 332).

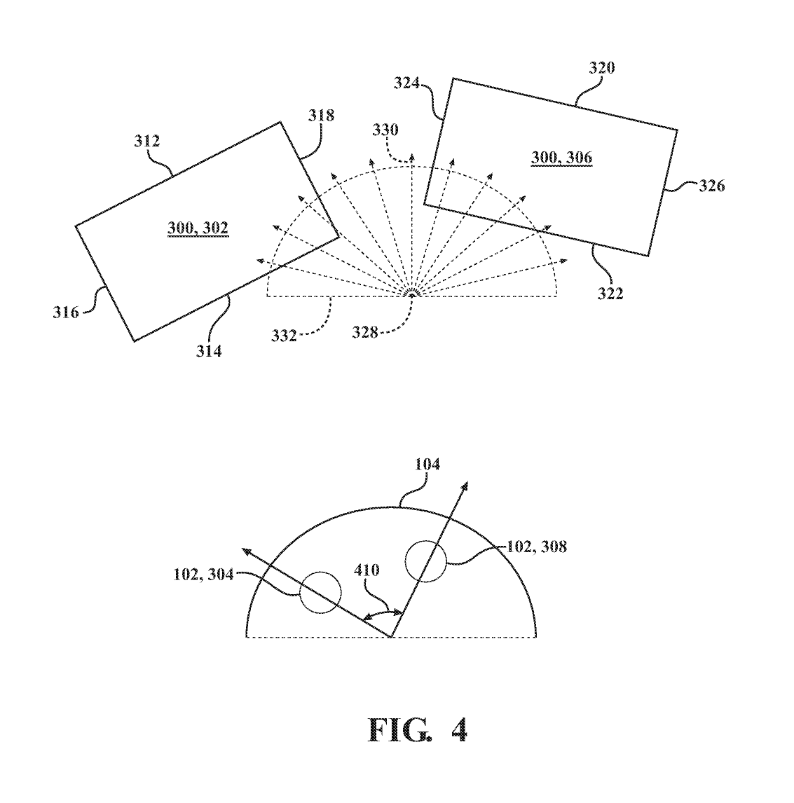

In one or more arrangements, the image alignment module(s) 122 can include instructions for shifting a position of one or more images 300. The position of the images 300 can be shifted with respect to another image 300. Additionally or alternatively, the position of the images 300 can be shifted with respect to the coordinate system 328. As shown in FIG. 4, adjustment of the first and/or second images 302, 306 may include both rotation and shifting of positions. For example, the second image 306 can be rotated such that the bottom 322 of the second image 306 extends parallel to the bottom 314 of the first image 302. Additionally, a position of the second image 306 can be shifted such that the bottom 322 of the second image 306 is in-line with the bottom 314 of the first image 302. As another example, the second image 306 can be rotated such that the bottom 322 of the second image 306 extends parallel to the second axis (for example, axis 332). Additionally, a position of the second image 306 can be shifted such that the bottom 322 of the second image 306 is in-line with the second axis (for example, axis 332).

Following adjustment of the first image 302 and/or the second image 306, the first image 302 and second image 306 can be aligned as represented in FIG. 5. In some instances, the image alignment module(s) 122 can include instructions to further adjust the first image 302 and/or second image 306 to overlay the first image 302 and second image 306. For example, a position of the first image 302 and/or the second image 306 can be shifted such to overlay the first image 302 and the second image 306. In both of these arrangements, following adjustment of the first image 302 and/or the second image 306, the images 302, 306 are aligned with one another. Following adjustment to cause alignment, the first image 302 and the second image 306 form a stereoscopic pair of images. It is noted that, as used hereinafter, the stereoscopic pair of images is correctively referring to the first image 302 and second image 306 following adjustment to align both images.

Referring back to FIG. 1A and FIG. 1B, the memory 120 can store one or more distance determining module(s) 124. The distance determining module(s) 124 can include instructions to determine a distance between the camera 102 and a feature in the field of view of the camera 102 (e.g., a feature located in a portion of the environment observable by the camera 102). The distance determining module(s) 124 can include instructions to determine the distance using the stereoscopic pair of images. In one or more arrangements, the distance determining module(s) 124 can include instructions to extract the feature represented in a first image (e.g., the first image 302) of a stereoscopic pair of images. The distance determining module(s) 124 can include instructions to extract the feature represented in a second image (e.g., the second image 306) of a stereoscopic pair of images. The distance determining module(s) 124 can include instructions to extract the features using, for instance, block matching techniques. The distance determining module(s) 124 can include instructions to determine a distance in pixels between a location of the feature represented in the first image and a location of the feature represented in the second image. The distance determining module(s) 124 can include instructions to generate a disparity map based on the determined distance in pixels between the locations of features represented in the respective images. Such information can be determined using, for instance, the systems and methods described by Chris McCormick in “Stereo Vision Tutorial—Part I,” Jan. 10, 2014, available at [“http://mccormickml.com/2014/01/10/stereo-vision-tutorial-part-i/”] which is incorporated herein by reference in its entirety. While this example is described, many other methods can be used to identify a distance in pixels between features represented in two or more images. Accordingly, the present disclosure is not limited to this example.

The distance determining module(s) 124 can include instructions to determine a distance between the camera 102 and the feature represented in both the first and second image. The distance determining module(s) 124 can include instructions to determine the distance using several inputs. The inputs can include the degree of rotation (e.g., 310 of FIG. 3), a distance between the axis of rotation 106 and the camera 102, a pixel density of images captured by the camera 102, the field of view 202 (of FIG. 2), and other inputs that may be used/are required for determining the distance between the camera 102 and the feature. The distance determining module(s) 124 can calculate the distance between the feature and the camera based on these inputs. For example, given a feature seen in both the first and second image, the distance can be determined using stereo triangulation techniques. For example, the pixel locations of the feature at the two different positions of the camera 102 form two corners of a triangle. Because the distance between the different positions is known, the length of the side between those two corners is also known. This information, plus a mathematical model of a camera lens, can be utilized to construct the rest of the triangle, and thereby provide the distance between the feature and the camera (i.e., the depth). Note that, where the camera arrangement 100 is implemented on a moving vehicle, for instance, additional information may be required, such as a distance traveled by the vehicle.

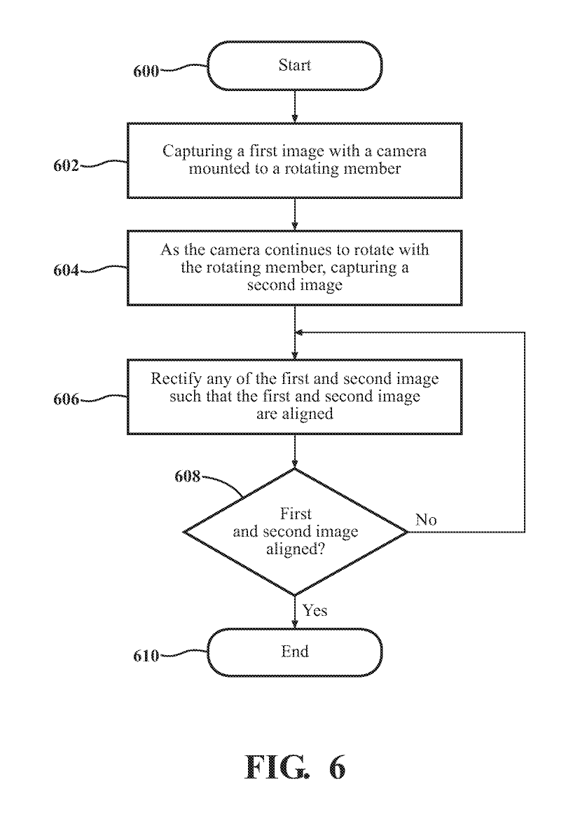

Now that various aspects of the camera arrangement 100 have been described, a method of forming a stereoscopic pair of images will be described with reference to FIG. 6. The flowchart shown in FIG. 6 provides only one example of forming a stereoscopic pair of images. The following disclosure should not be limited to each and every function block shown in FIG. 6. To the contrary, the method does not require each and every function block shown. In some examples, the method may include additional function blocks. Further, the method does not need to be performed in the same chronological order shown in FIG. 6.

The method can begin at starting block 600. The method can begin when the rotating member 104 rotates. In some instances, the method can begin when the rotating member 104 rotates less than a predetermined speed (e.g., a predetermined number of rotations per minute, for example). The method can proceed to function block 602.

At function block 602, the camera 102 captures a first image (e.g., image 302). As stated above, the camera 102 can be mounted to the rotating member 104. For instance, the camera 102 can be mounted to an outwardly facing surface 108 of the rotating member 104 with the lens 112 facing outwardly from the outwardly facing surface 108. The camera 102 can be mounted between the axis of rotation 106 and the perimeter 114 of the rotating member. The method can continue to function block 604.

At function block 604, the camera 102 captures a second image (e.g., image 306) as the camera continues to rotate with the rotating member 104. The camera 102 can rotate a degree of rotation (e.g., the degree of rotation 310) which can be measured using the rotational sensor(s) 116. In some instances, the degree of rotation can be 180°. In other instances, the degree of rotation can be greater than or less than 180°. The method can continue to function block 606.

At function block 606, the processor(s) 118 can rectify any of the first image (e.g., the image captured at function block 602) and the second image (e.g., the image captured at function block 604) using instructions from the image alignment module(s) 122. The first and/or second image can be rectified such that the first and second images are aligned. The first and/or second image can be rotated, shifted, etc. In some instances, the first and/or second image can be rotated, shifted, etc. with respect to the second and/or first image. In other instances, the first and/or second image can be rotated, shifted, etc. with respect to a coordinate system 328. The method can proceed to decision block 608.

At decision block 608, the processor(s) 118 can determine whether the first and second images are aligned using instructions from the image alignment module(s) 122. The processor(s) 118 can determine, for instance, whether the first and second images are aligned based on a pose of the sides, top, and/or bottom of each image with respect to the other image. Additionally or alternatively, the processor(s) 118 can determine, for instance, whether the first and second images are aligned based on a pose of the sides, top, and/or bottom of each image with respect to the coordinate system 328. If, at decision block 608, the first and second images are aligned, the method can proceed to ending block 610. However, if, at decision block 608, the first and second images are not aligned, the method can proceed back to function block 606.

At ending block 610, the method can end. The method can end following the first and second images being aligned.

In one or more arrangements, when the first and second images are aligned, the processor(s) 118 can determine a distance between one or more features represented in both the first and second image and the camera 102 using instructions from the distance determining module(s) 124. The processor(s) 118 can determine a distance in pixels between the feature represented in the first image and the feature represented in the second image. The processor(s) 118 can determine the distance between the features based, at least, on the distance in pixels between the features represented in the first and second images.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the drawings, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the maintenance conditions enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may be executed entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for forming a stereoscopic pair of images, the system comprising:
a rotating member having an outwardly facing surface, the rotating member rotating about an axis of rotation extending through the outwardly facing surface;
a camera operatively connected to the outwardly facing surface of the rotating member, the camera having a field of view extending outwardly from the outwardly facing surface of the rotating member, the camera rotating with the rotating member about the axis of rotation;
a processor operatively connected to the camera; and
memory operatively connected to the processor, the memory storing instructions that, when executed by the processor, cause the processor to:
capture a first image representing a portion of an environment with the camera;
as the camera rotates about the axis of rotation with the rotating member, capturing a second image representing substantially the same portion of the environment as the first image, the second image having a perspective offset from the first image; and
rectify the second image such that the first image and the rectified second image are aligned, wherein the first image and the rectified second image form a stereoscopic pair of images.

2. The system of claim 1, further comprising:
a rotational sensor positioned to detect a degree of rotation of the rotating member, and wherein the instructions that, when executed by the processor, cause the processor to rectify the second image further comprise instructions to:
rotate the second image according to the degree of rotation of the rotating member, as detected by the rotational sensor, between the camera capturing the first and second image.

3. The system of claim 2, wherein the degree of rotation is 180°, and wherein the second image is rotated 180°.

4. The system of claim 2, wherein the instructions that, when executed by the processor, cause the processor to rectify the second image further comprise instructions to:
shift a position of the second image to align the first image and the second image.

5. The system of claim 1, wherein the first image and the rectified second image are laterally aligned.

6. The system of claim 5, wherein a bottom of the first image is parallel to and in line with a bottom of the rectified second image.

7. The system of claim 1, wherein the memory further stores instructions to:
determine a distance in pixels between a location of a feature of the environment represented in the first image and a location of the feature represented in the rectified second image; and
determine a distance between the camera and the feature based, at least, on the distance in pixels between the locations.

8. A method of forming a stereoscopic pair of images, the method comprising:
capturing a first image representing a portion of an environment with a camera having a field of view extending in a direction, the camera mounted to a rotating member having an axis of rotation extending in the direction of the field of view of the camera, the camera rotating with the rotating member;
as the camera rotates about the axis of rotation with the rotating member, capturing a second image, the second image representing substantially the same portion of the environment as the first image, the second image having a perspective offset from the first image; and
rectifying the second image such that the first image and the rectified second image are aligned, wherein the first image and the rectified second image form a stereoscopic pair of images.

9. The method of claim 8, wherein rectifying the second image further comprises:
rotating the second image according to a degree of rotation of the rotating member between capturing the first and second image.

10. The method of claim 9, wherein the degree of rotation is 180°, and wherein the second image is rotated 180°.

11. The method of claim 9, wherein rectifying the second image further comprises:
shifting a position of the second image to align the first image and the second image.

12. The method of claim 8, wherein the first image and the rectified second image are laterally aligned.

13. The method of claim 12, wherein a bottom of the first image is parallel to and in line with a bottom of the rectified second image.

14. The method of claim 8, further comprising:
determining a distance in pixels between a location of a feature of the environment represented in the first image and a location of the feature represented in the rectified second image; and
determining a distance between the camera and the feature based on the distance in pixels between the locations.

15. A method of forming a stereoscopic pair of images, the method comprising:
capturing a first image representing a portion of an environment with a camera having a field of view extending in a direction, the camera mounted to a rotating member having an axis of rotation extending in the direction of the field of view of the camera, the camera rotating with the rotating member;
as the camera rotates about the axis of rotation with the rotating member, capturing a second image, the second image representing substantially the same portion of the environment as the first image, the second image having a perspective offset from the first image; and
rectifying the first image such that the rectified first image and the second image are aligned, wherein the rectified first image and the second image form a stereoscopic pair of images.

16. The method of claim 15, wherein rectifying the first image further comprises:
rectifying the first image with respect to a coordinate system; and wherein the method further comprises:
rectifying the second image with respect to the coordinate system,
wherein the rectified first image and the rectified second image are aligned with each other according to the coordinate system, wherein the rectified first image and the rectified second image form the stereoscopic pair of images.

17. The method of claim 15, further comprising:
determining a distance in pixels between a location of a feature in the rectified first image and a location of the feature in the second image; and
determining a distance between the camera and the feature in both the first and second image based on the distance in pixels between the location of the feature in the first image and the location of the feature in the second image.

18. The method of claim 15, wherein rectifying the first image further comprises:
rotating the first image according to a degree of rotation of the rotating member between capturing the first and second image.

19. The method of claim 18, wherein the degree of rotation is 180°, and wherein the first image is rotated 180°.

20. The method of claim 18, wherein rectifying the first image further comprises:
shifting a position of the first image to align the first image and the second image.
